(19) United States
(12) Patent Application Publication
(10) Pub. No.: US 2026/0238840 A1
(43) Pub. Date: Aug. 13, 2026

(54) WATCH TIME UNITS AND AD-CONDITIONED MONETIZATION CONTROL FOR A USER-GENERATED VIDEO SHARING PLATFORM

(71) Applicant: ADRIS CHAKRABORTY, new york city, NY (US)

(72) Inventor: ADRIS CHAKRABORTY, new york city, NY (US)

(21) Appl. No.: 19/439,745

(22) Filed: Jan. 5, 2026

Related U.S. Application Data
(63) Continuation-in-part of application No. 18/788,004, filed on Jul. 29, 2024.
(60) Provisional application No. 63/545,363, filed on Oct. 24, 2023.

(51) Int. Cl. H04N 21/24; G06Q 40/12

(52) U.S. Cl. CPC H04N 21/2408; H04N 21/2407; G06Q 40/125

(57) ABSTRACT

A computer-implemented method for controlling monetization of watch time in a user-generated video sharing platform is provided. The method includes receiving, by one or more processors, structured playback event records and advertisement consumption event records comprising timestamps, identifiers, and event types. The method includes segmenting content playback duration into fixed-length watch time units while excluding advertisement playback intervals. The method includes detecting advertisement consumption events and determining whether each advertisement was fully completed without skipping. The method includes associating advertisement consumption events with one or more watch time units using defined temporal correlation rules based on advertisement placement context. The method further includes updating a monetization eligibility state for each associated watch time unit, including transitioning watch time units into monetized or invalidated states.

### CLAIM OF PRIORITY

This application claims priority to and is a continuation in part of U.S. patent application Ser. No. 18/788,004, filed on Jul. 29, 2024, and titled WATCH TIME UNITS AND THE REWARD SHARE MECHANISM FOR A USER-GENERATED VIDEO SHARING PLATFORM. This patent application is hereby incorporated by reference in its entirety.

U.S. patent application Ser. No. 18/788,004 claims priority to U.S. Provisional Patent Application No. 63/545,363, filed on 24 Oct. 2023, and titled WATCH TIME UNITS AND THE REWARD SHARE MECHANISM FOR A USER-GENERATED VIDEO SHARING PLATFORM. This provisional patent application is hereby incorporated by reference in its entirety.

### BACKGROUND

### Field of Invention

The present invention relates generally to digital media platforms and monetization systems, and more particularly to systems and methods for controlling monetization eligibility and revenue allocation based on conditionally monetized watch time units within a user-generated video sharing platform.

### Background

User-generated video sharing platforms rely heavily on advertisement-supported revenue models in which advertising impressions are served in connection with playback of digital video content. In conventional systems, monetization of content is typically decoupled from viewer advertisement consumption behavior, such that content watch time may be treated as monetized by default regardless of whether advertisements are fully viewed or skipped by the viewer. As a result, existing platforms generally account for advertisement revenue independently of the specific segments of content watch time that generated such revenue.

In many existing implementations, advertisement skipping primarily affects advertiser billing or impression counts, but does not directly invalidate or revoke monetization of corresponding content watch time. Consequently, current systems lack a deterministic mechanism for correlating individual advertisement consumption events to discrete segments of content watch time in a manner that enforces monetization eligibility conditions. This disconnect can lead to imprecise revenue attribution, limited fraud resistance, and a lack of transparency in how advertisement earnings are mapped to viewer activity.

Additionally, conventional revenue-sharing mechanisms on video sharing platforms primarily allocate advertising revenue between the platform operator and content creators, with little or no consideration given to the contribution of viewer watch time as a monetizable resource. Where viewer rewards are offered, such systems typically rely on abstract point systems, promotional incentives, or tokenized constructs that are not directly derived from actual advertisement earnings and that lack deterministic linkage to verified watch time consumption.

Furthermore, existing systems do not adequately distinguish between different advertisement placement contexts, such as pre-roll, mid-roll, and post-roll advertisements, when determining how advertisement revenue should be attributed to content watch time. In particular, prior approaches fail to enforce directional or temporal adjacency constraints that define whether content watched before or after an advertisement qualifies for monetization based on verified advertisement completion.

Accordingly, there exists a need for improved systems and methods that treat content watch time as a latent, non-monetized resource by default, and that conditionally convert such watch time into monetized units only upon satisfaction of defined advertisement consumption criteria. There is further a need for a computational framework that correlates advertisement events to specific watch time segments, invalidates monetization eligibility upon advertisement skipping, and deterministically allocates advertisement revenue among platform participants based on verified, ad-conditioned watch time units.

### BRIEF SUMMARY OF THE INVENTION

In one aspect, a computer-implemented method for controlling monetization of watch time in a user-generated video sharing platform is provided. The method includes receiving, by one or more processors, structured playback event records and advertisement consumption event records comprising timestamps, identifiers, and event types. The method includes segmenting, by the one or more processors, content playback duration into fixed-length watch time units while excluding advertisement playback intervals. The method includes detecting, by the one or more processors, one or more advertisement consumption events and determining whether each detected advertisement consumption event satisfies completion criteria without skipping. The method includes associating, by the one or more processors, at least one advertisement consumption event with one or more watch time units using defined temporal correlation rules based on an advertisement placement context. The method includes updating, by the one or more processors, a monetization eligibility state for each associated watch time unit based on the advertisement consumption event and the temporal correlation rules, wherein updating the monetization eligibility state includes transitioning watch time units into a monetized state or an invalidated state. The method includes aggregating, by the one or more processors, advertisement earnings from verified advertisement consumption events. The method includes computing, by the one or more processors, a per-unit monetary value for monetized watch time units using deterministic arithmetic operations based on aggregated advertisement earnings and a count of monetized watch time units. The method includes generating, by the one or more processors, revenue allocation outputs for a content creator, a viewer, and a platform operator based on the per-unit monetary value and the monetized watch time units.

### BRIEF DESCRIPTION OF THE DRAWINGS

FIG. 1 illustrate an example process for managing a user-generated video sharing platform, according to some embodiments.

FIG. 2 illustrates an example process for rewards related to watch-time units, according to some embodiments.

FIG. 3 illustrates an example screenshot of a user-generated video sharing platform, according to some embodiments.

FIG. 4 depicts an exemplary computing system that can be configured to perform any one of the processes provided herein.

FIG. 5 illustrates an example process for a distribution mechanism of earnings between a creator, a viewer and a user-generated video sharing platform, according to some embodiments.

FIG. 6 illustrates an example process for monetization eligibility state transition, according to some embodiments.

FIG. 7 illustrates an example process for ad-to-watch-time temporal correlation, according to some embodiments.

FIG. 8 illustrates an example process for monetized watch time unit valuation, according to some embodiments.

FIG. 9 illustrates an example process for monetization verification and fraud resistance, according to some embodiments.

FIG. 10 illustrates an example system for implementing ad-conditioned monetization control of watch time units, according to some embodiments.

The Figures described above are a representative set and are not an exhaustive with respect to embodying the invention.

### DESCRIPTION

Disclosed are a system, method, and article of manufacture for watch time units and ad-conditioned monetization control for a user-generated video sharing platform. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment, according to some embodiments. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Cloud computing architecture refers to the components and subcomponents required for cloud computing. These components typically consist of a front-end platform (e.g. fat client, thin client, mobile), back-end platforms (servers, storage), a cloud-based delivery, and a network (e.g. Internet, Intranet, Intercloud). Combined, these components can make up cloud computing architecture. Cloud computing architectures and/or platforms can be referred to as the ‘cloud’ herein as well.

Online video platform (OVP) enables users to upload, convert, store, and play back video content on the Internet, often via a private server structured, large-scale system that may generate revenue. Users can upload video content via the hosting service's website, mobile or desktop application, or other interfaces (API), and provides embed codes or links that allow others to view the video content.

Social media are interactive technologies that facilitate the creation and sharing of content, ideas, interests, and other forms of expression through virtual communities and networks. While challenges to the definition of social media arise due to the variety of stand-alone and built-in social media services currently available, there are some common features: Social media are interactive Web 2.0 Internet-based applications; user-generated content—such as text posts or comments, digital photos or videos, and data generated through all online interactions—is the lifeblood of social media; users create service-specific profiles for the website or app that are designed and maintained by the social media organization; and social media helps the development of online social networks by connecting a user's profile with those of other individuals or groups.

Ad-conditioned watch time unit refers to a fixed-duration segment of content watch time for which monetization eligibility is determined based on one or more advertisement consumption events temporally correlated with the segment, such that the watch time unit becomes monetized only upon verification of qualifying advertisement completion without skipping.

Advertisement consumption event refers to a system-detected playback event associated with an advertisement, including full completion, partial playback, skipping, or interruption, where the event is used as an input for determining monetization eligibility of one or more correlated watch time units.

Monetization eligibility state refers to a computational state associated with a segment of content watch time that indicates whether the segment is non-monetized, conditionally eligible for monetization, monetized, or invalidated, based on detected advertisement consumption events and defined temporal correlation rules.

Monetized watch time unit valuation engine refers to a computational module configured to calculate a per-unit monetary value for monetized watch time units by allocating verified advertisement earnings across a set of monetized watch time units after creator allocation and excluding any watch time units invalidated due to advertisement skipping or verification failure.

Temporal correlation window refers to a defined time relationship between an advertisement playback interval and one or more segments of content watch time, specifying whether monetization eligibility applies to content viewed before the advertisement, after the advertisement, or within a defined adjacency threshold relative to the advertisement.

### Example Systems and Methods

In some embodiments, the disclosed system implements a real-time computational framework for determining monetized watch time by continuously evaluating viewer engagement with digital content and associated advertisement consumption events. The system performs calculations at fine-grained time intervals to determine whether content watch time accumulated by a viewer qualifies for monetization based on detected playback behavior. Content engagement acts as a trigger for advertisement serving, such that advertisements are served in response to viewer engagement with content rather than as an isolated monetization activity. Advertisement playback alone does not cause monetization of watch time; instead, monetization eligibility arises only when content watch time has been accumulated and a temporally correlated advertisement is fully consumed without skipping.

The disclosed system treats content watch time as a latent, non-monetized resource by default and converts such watch time into monetized watch time only upon satisfaction of defined conditions. Watch time accumulates exclusively during playback of content and does not accumulate during advertisement playback. Watch time is segmented into fixed-duration watch time units, such as thirty-second intervals, which serve as the basis for subsequent monetization calculations. A watch time unit becomes monetized only when a qualifying advertisement consumption event is detected and verified, and when the advertisement is temporally correlated with content watch time occurring before or after the advertisement, depending on the advertisement placement context. If an advertisement is skipped or fails verification, the associated watch time units are transitioned into a non-monetized or invalidated state and excluded from monetization calculations.

The disclosed approach differs from conventional video monetization systems by enforcing a causal and conditional relationship between content watch time and advertisement consumption behavior. In existing platforms, watch time is typically treated as monetized independently of whether advertisements are skipped, and advertisement revenue is accounted for without granular correlation to specific segments of content watch time. In contrast, the disclosed system maps advertisement-generated earnings to discrete, verified segments of content watch time and allocates revenue based entirely on advertisements that are served and fully consumed. This conditional monetization framework enables deterministic calculation of creator earnings, viewer rewards, and platform share based on verified monetized watch time units, thereby providing a controlled and auditable monetization mechanism that is responsive to real-time viewer behavior.

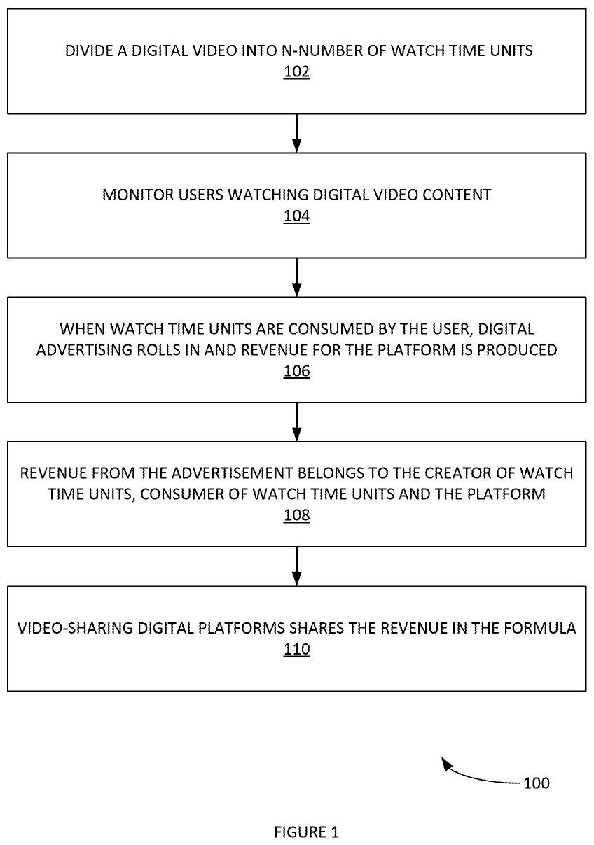

FIG. 1 illustrate an example process 100 for managing a user-generated video sharing platform, according to some embodiments. Process 100 can enable an online user-generated video sharing platform to receive uploads of digital videos. In step 102, process 100 can divide a digital video into n-number of watch time units. When a creator creates video content of a specified time period (e.g. 30 secs or more), it actually produces watch time units. A watch time unit is defined by 30 secs of watch time duration for a video.

In step 104, process 100 monitors users watching digital video content. For example, when a viewer is watching that video content, the user consumes the watch time units being produced. In step 106, when watch time units are consumed by the user, digital advertising rolls in and revenue for the platform is produced.

In step 108, the revenue from the advertisement belongs to the creator of watch time units, consumer of watch time units and the platform. In step 110, the video-sharing digital platforms shares the revenue in the formula. In one example, the revenue sharing model can be as follows:

For $1 revenue produced, users who create the watch time units get a share of X %, 30% of what remains ($1−X % of $1) is rewarded to users who consume the watch time units, and the balance stays with the platform.

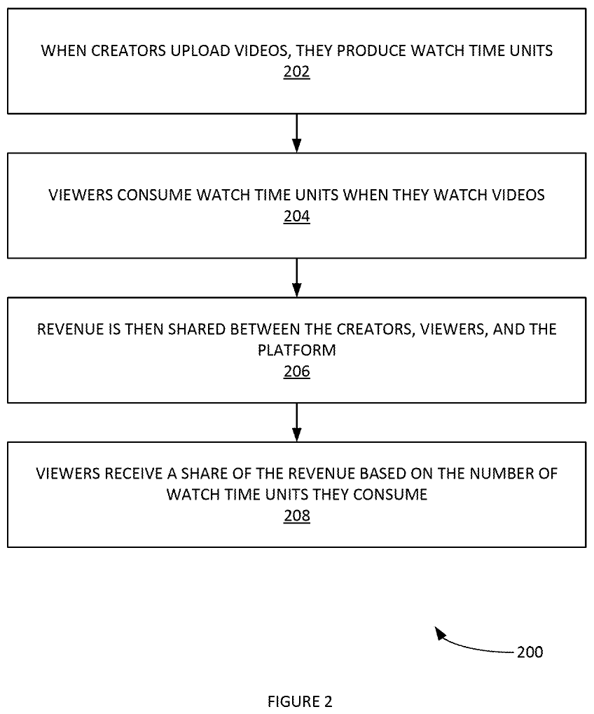

FIG. 2 illustrates an example process 200 for rewards related to watch-time units, according to some embodiments. It is noted that watch time units and the reward share mechanism are used to reward creators and viewers for their contributions to a user-generated video sharing platform. When creators upload videos, they produce watch time units in step 202. Viewers consume watch time units when they watch videos in step 204. As viewers consume watch time units, advertising rolls are played, and revenue is generated. This revenue is then shared between the creators, viewers, and the platform in step 206. Creators receive a share of the revenue based on the number of watch time units they produce. Viewers receive a share of the revenue based on the number of watch time units they consume in step 208. The platform retains a balance of the revenue to cover its operating costs. This system is more equitable than traditional revenue sharing mechanisms, which typically favor creators over viewers. By rewarding viewers for their time, watch time units and the reward share mechanism incentivize viewers to watch more videos. This increased viewership benefits both creators and the platform.

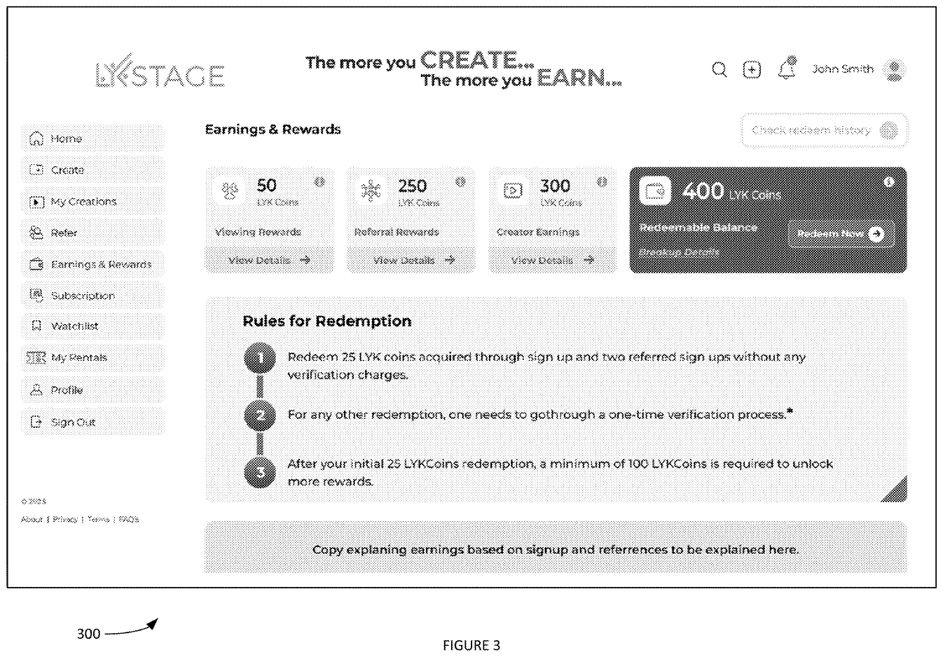

FIG. 3 illustrates an example screenshot 300 of a user-generated video sharing platform, according to some embodiments.

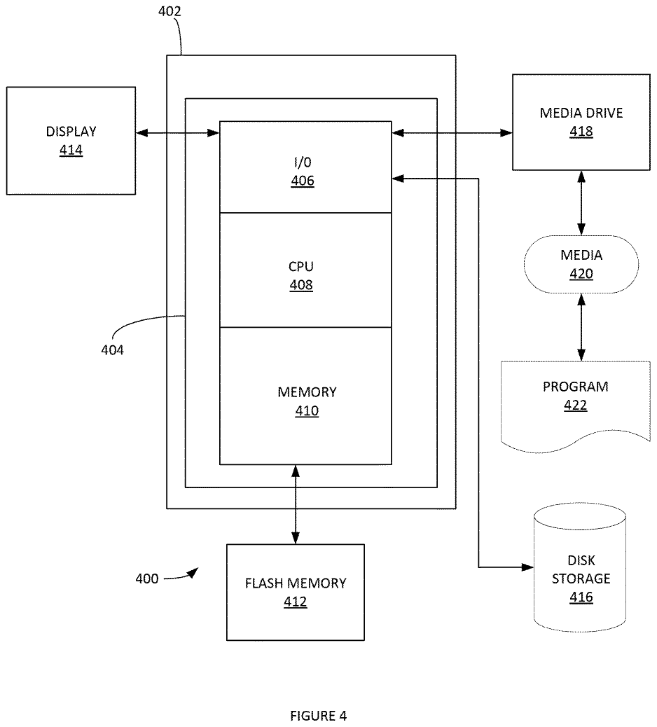

FIG. 4 depicts an exemplary computing system 400 that can be configured to perform any one of the processes provided herein. In this context, computing system 400 may include, for example, a processor, memory, storage, and I/O devices (e.g., monitor, keyboard, disk drive, Internet connection, etc.). However, computing system 400 may include circuitry or other specialized hardware for carrying out some or all aspects of the processes. In some operational settings, computing system 400 may be configured as a system that includes one or more units, each of which is configured to carry out some aspects of the processes either in software, hardware, or some combination thereof.

FIG. 4 depicts computing system 400 with a number of components that may be used to perform any of the processes described herein. The main system 402 includes a motherboard 404 having an I/O section 406, one or more central processing units (CPU) 408, and a memory section 410, which may have a flash memory card 412 related to it. The I/O section 406 can be connected to a display 414, a keyboard and/or other user input (not shown), a disk storage unit 416, and a media drive unit 418. The media drive unit 418 can read/write a computer-readable medium 420, which can contain programs 422 and/or data. Computing system 400 can include a web browser. Moreover, it is noted that computing system 400 can be configured to include additional systems in order to fulfill various functionalities. Computing system 400 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### ADDITIONAL EMBODIMENTS

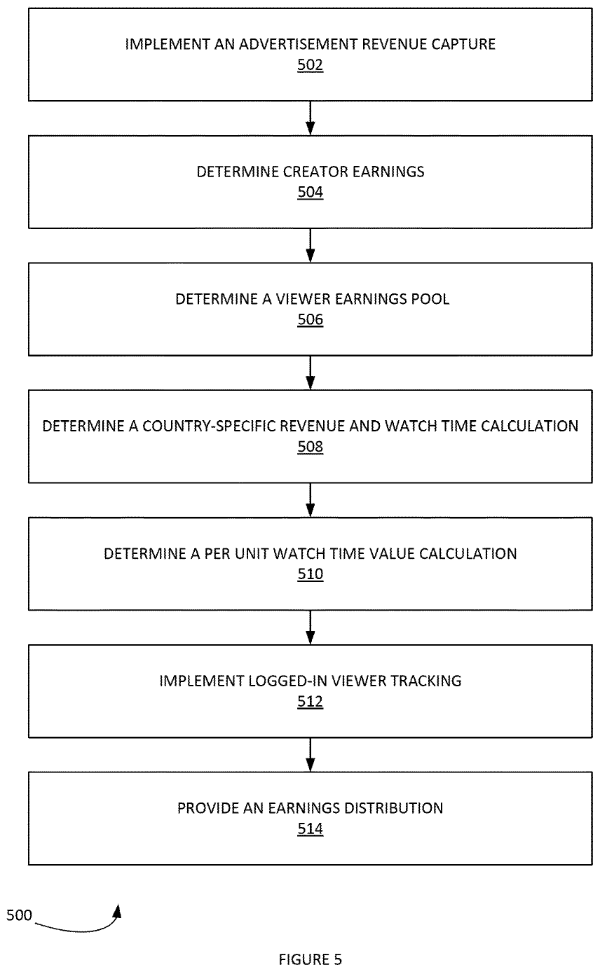

FIG. 5 illustrates an example process 500 for a distribution mechanism of earnings between a creator, a viewer and a user-generated video sharing platform, according to some embodiments. In step 502, process 500 implements an advertisement revenue capture. For example, every twenty-four (24) hours, process 500 can track the number of advertisements displayed on each piece of content and calculate the total ad revenue based on impressions and views generated by those advertisements.

In step 504, process 500 determine creator earnings. In one example, the total advertisement revenue for the content is determined, and the creator receives their entitled percentage first. In step 506, process 500 determines a viewer earnings pool. From the remaining revenue, thirty percent (30%) can be set aside to reward viewers.

In step 508, process 500 determines a country-specific revenue and watch time calculation. Process 500 can calculate the total advertisement revenue and total watch time units for each country. This can involve determining how much each country has contributed to the total watch time views and the revenue generated from those views.

In step 510, process 500 determines a per unit watch time value calculation. The viewer earnings pool for each country is divided by the total watch time units from that country to determine the value of each watch time unit. In step 512, process 500 implements logged-in viewer tracking. Here, process 500 can identify the logged-in users who watched the content and calculate the total watch time units consumed by these viewers in each country.

In step 514, process 500 can provide an earnings distribution. The total watch time units consumed by logged-in viewers in each country are multiplied by the value of each watch time unit for that country. This determines the total viewer earnings for each country. These earnings are then proportionately distributed to each viewer based on their individual watch time consumption. This method ensures that both creators and viewers are fairly compensated based on the advertisement revenue generated and the watch time contributed in their respective countries. This version incorporates the country-specific calculations for both watch time and revenue, ensuring an accurate distribution of earnings.

### Watch Time Units and Ad-Conditioned Monetization Control for a User-Generated Video Sharing Platform

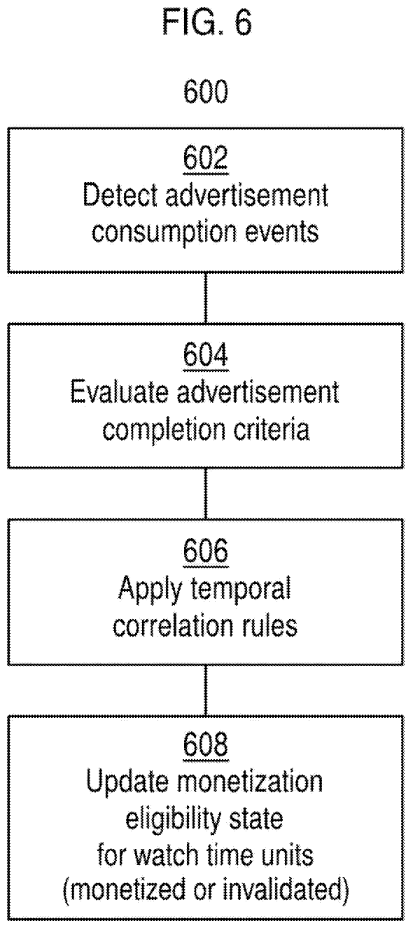

FIG. 6 illustrates an example process 600 for monetization eligibility state transition, according to some embodiments. In step 602, process 600 detects one or more advertisement consumption events associated with playback of digital content, including identifying whether an advertisement was fully completed, partially played, skipped, or interrupted, and recording corresponding event timestamps.

In step 604, process 600 evaluates the detected advertisement consumption events to determine whether advertisement completion criteria are satisfied, including determining whether the advertisement was viewed in its entirety without skipping and whether the advertisement qualifies for monetization based on defined validation rules.

In step 606, process 600 applies temporal correlation rules to associate the advertisement consumption event with one or more segments of content watch time, including identifying one or more watch time units that fall within a defined temporal correlation window relative to the advertisement playback.

In step 608, process 600 updates a monetization eligibility state for each associated watch time unit based on the evaluation and temporal correlation, including transitioning watch time units into a monetized state when advertisement completion criteria are satisfied or transitioning watch time units into an invalidated state when the advertisement is skipped or fails verification, and excluding invalidated watch time units from monetization calculations.

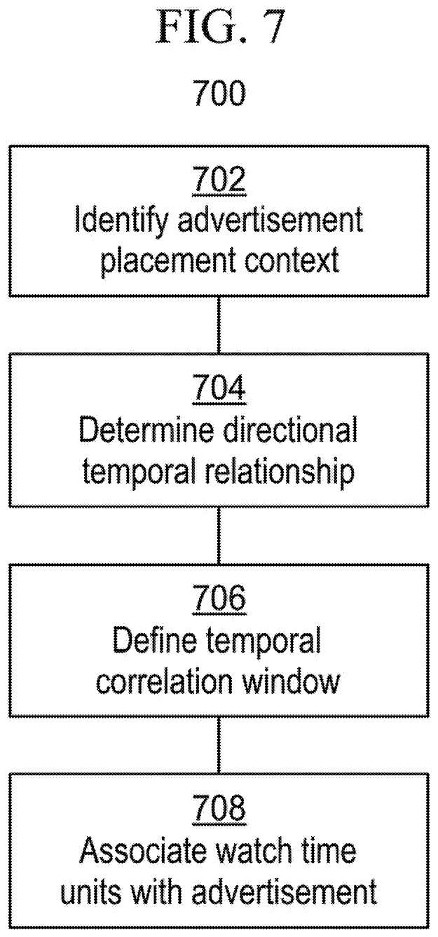

FIG. 7 illustrates an example process 700 for ad-to-watch-time temporal correlation, according to some embodiments. In step 702, process 700 identifies an advertisement placement context associated with a digital content playback session, including determining whether the advertisement is classified as a pre-roll advertisement, a mid-roll advertisement, or a post-roll advertisement.

In step 704, process 700 determines a directional temporal relationship between the advertisement playback interval and content watch time based on the advertisement placement context, including identifying whether monetization eligibility applies to content watch time occurring after the advertisement, before the advertisement, or within a defined adjacency threshold.

In step 706, process 700 defines a temporal correlation window relative to the advertisement playback interval, including establishing one or more time boundaries for associating content watch time units with the advertisement consumption event.

In step 708, process 700 associates one or more watch time units with the advertisement based on the defined temporal correlation window, such that only watch time units falling within the window are eligible for monetization evaluation.

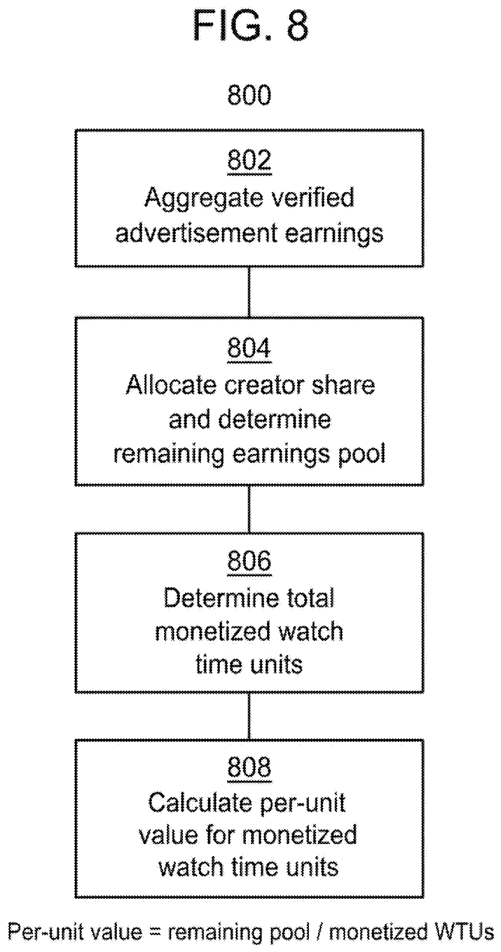

FIG. 8 illustrates an example process 800 for monetized watch time unit valuation, according to some embodiments. In step 802, process 800 aggregates advertisement earnings generated from one or more verified advertisement consumption events within a defined accounting interval. In step 804, process 800 allocates a creator share from the aggregated advertisement earnings based on defined creator allocation rules, resulting in a remaining earnings pool available for viewer valuation.

In step 806, process 800 determines a total number of monetized watch time units by excluding any watch time units that remain non-monetized or have been invalidated due to advertisement skipping or verification failure.

In step 808, process 800 calculates a per-unit monetary value for monetized watch time units by dividing the remaining earnings pool by the total number of monetized watch time units and stores the calculated value for subsequent reward distribution.

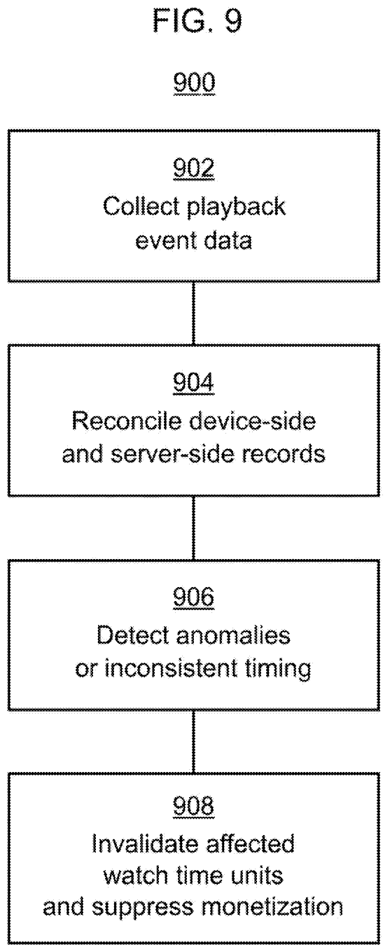

FIG. 9 illustrates an example process 900 for monetization verification and fraud resistance, according to some embodiments. In step 902, process 900 collects playback event data associated with content watch time and advertisement consumption, including device-side timestamps, server-side logs, and session identifiers.

In step 904, process 900 reconciles the collected playback event data by comparing device-side timestamps with server-side records to verify consistency of advertisement consumption and content watch time.

In step 906, process 900 evaluates the reconciled playback event data to detect anomalies indicative of automated playback, event manipulation, or inconsistent timing behavior that may invalidate monetization eligibility.

In step 908, process 900 suppresses monetization eligibility for one or more watch time units associated with detected anomalies by transitioning the affected watch time units into an invalidated state and excluding the invalidated watch time units from monetization calculations.

In order to quantify content watch time in a uniform and deterministic manner, the system computes watch time units based on measured content playback duration. Total watch time units can be expressed as:

WTU_total=└T_content/U┘,

where T_content represents a total duration of content watch time measured in seconds for a given viewer session or accounting interval, U represents a fixed watch time unit duration in seconds, and └ ┘ denotes a floor operation. In example implementations, U is set to thirty (30) seconds. Watch time accumulated during advertisement playback is excluded from T_content, such that WTU_total reflects only active consumption of content.

Monetized watch time units are determined by conditioning watch time units on verified advertisement consumption events. Monetized watch time units can be expressed as: WTU_monetized=ΣWTU_i·E_i, where WTU_i represents an individual watch time unit segment and E_i represents a monetization eligibility indicator associated with that watch time unit. The eligibility indicator E_i is assigned a value of 1 when a temporally correlated advertisement consumption event is verified as fully completed without skipping, and a value of 0 when the advertisement is skipped, interrupted, or fails verification. Watch time units associated with E_i=0 are excluded from monetization and do not contribute to subsequent valuation calculations.

Total advertisement earnings associated with a session or accounting period are computed by aggregating revenue from verified advertisement consumption events. Total earnings can be expressed as:
E_total=ΣR_j, where R_j represents an earnings value generated by an individual advertisement impression or playback event that has been fully completed and verified. Advertisements that are skipped or fail verification do not contribute to E_total. The aggregated earnings E_total form the gross revenue pool from which creator, viewer, and platform allocations are derived.

Creator earnings are allocated prior to viewer valuation according to a predefined creator allocation percentage. Creator earnings can be expressed as: E_creator=α·E_total, where a represents a creator allocation fraction between 0 and 1. Remaining earnings available for viewer and platform allocation can be expressed as: E_remaining=E_total−E_creator. The creator allocation is independent of the number of monetized watch time units and is determined solely based on verified advertisement earnings.

A per-unit monetary value for monetized watch time units is computed using the remaining earnings pool. The value per monetized watch time unit can be expressed as: V_WTU=(β·E_remaining)/WTU_monetized, where β represents a viewer allocation fraction between 0 and 1. Viewer rewards can then be expressed as:

E_viewer=WTU_monetized·V_WTU.

Platform earnings can be expressed as:

E_platform=E_remaining−E_viewer.

In this manner, viewer rewards are deterministically derived from verified advertisement earnings and conditioned monetized watch time units, while platform earnings emerge as a residual after creator and viewer allocations.

The processes and equations introduced in FIGS. 6-9 operate as an extension of the platform-level workflow illustrated in FIGS. 1 and 2, which describe the generation and consumption of watch time units within a user-generated video sharing platform. In FIGS. 1 and 2, watch time units are created through content uploads and consumed through viewer playback. The equations defining total watch time units and monetized watch time units refine this workflow by mathematically formalizing how content playback duration is segmented and how such segments are selectively included or excluded from monetization calculations. In this manner, the equations provide a deterministic accounting layer that underlies the watch time unit production and consumption processes already depicted.

Process 600 integrates directly with the monitoring and revenue capture steps illustrated in FIG. 1 by introducing a monetization eligibility state transition layer that governs when consumed watch time units are permitted to contribute to revenue calculations. While FIG. 1 depicts advertisement playback and revenue generation as part of the viewing process, process 600 constrains those operations by evaluating advertisement consumption events and updating monetization eligibility states for corresponding watch time units. The monetization eligibility indicators used in the equations are produced by process 600 and serve as gating variables that determine whether individual watch time units are included in the monetized watch time unit total.

Process 700 complements the advertisement playback logic shown in FIGS. 1 and 2 by introducing temporal correlation rules that bind advertisement consumption events to specific segments of content watch time. The directional and contextual association between advertisements and watch time units established in process 700 ensures that only watch time units falling within defined temporal correlation windows are considered eligible for monetization. These associations directly affect the assignment of eligibility indicators used in the monetized watch time unit equation and ensure that advertisement earnings are causally linked to content watch time in a manner consistent with the platform workflows previously described.

Process 800 integrates with the revenue distribution mechanisms illustrated in FIG. 5 by providing a valuation pipeline that transforms aggregated advertisement earnings into per-unit monetary values for monetized watch time units. The equations defining total earnings, creator allocation, remaining earnings, and per-unit watch time value formalize the revenue sharing steps depicted in FIG. 5 and introduce an explicit dependency on the total number of monetized watch time units. By excluding non-monetized and invalidated watch time units from the valuation denominator, process 800 ensures that viewer and platform allocations are derived only from verified, ad-conditioned watch time.

Process 900 integrates with the platform monitoring and tracking components illustrated in FIGS. 1 and 4 by providing verification and fraud-resistance logic that validates the event data used by processes 600-800 and by the associated equations. The reconciliation and anomaly detection steps in process 900 determine whether advertisement consumption events and content watch time measurements are sufficiently reliable to support monetization. Watch time units that fail verification are invalidated and excluded from the monetized watch time unit total, thereby maintaining consistency between the computational equations and the operational processes depicted across FIGS. 1-5.

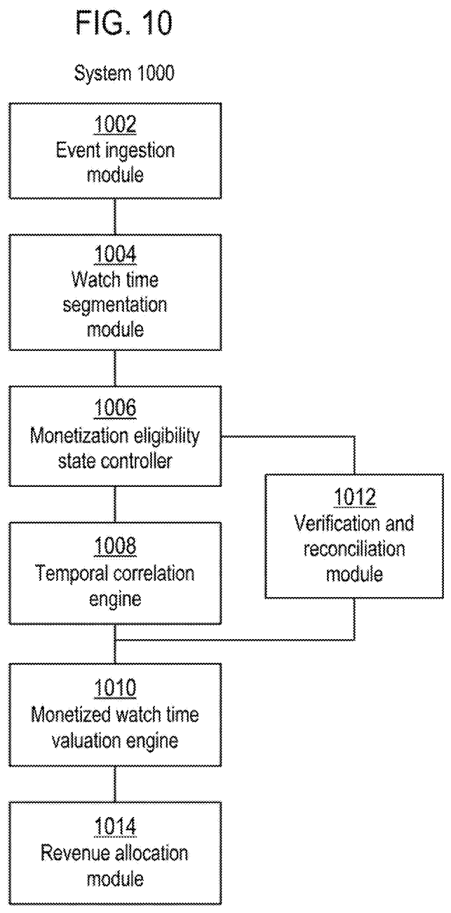

FIG. 10 illustrates an example system 1000 for implementing ad-conditioned monetization control of watch time units, according to some embodiments. System 1000 operates as a computer-implemented control architecture that processes media playback events, advertisement consumption events, and time-segmented watch data to determine monetization eligibility and revenue allocation in real time.

System 1000 includes an event ingestion module 1002 configured to receive and normalize playback-related events, including content playback start and stop events, advertisement playback events, skip events, completion events, and associated timestamps generated by client devices and server-side components. The event ingestion module 1002 produces a unified event stream suitable for deterministic processing and prevents monetization decisions from being based on inferred or aggregated behavior alone.

System 1000 further includes a watch time segmentation module 1004 configured to measure content playback duration and segment the measured duration into fixed-length watch time units. The watch time segmentation module 1004 excludes advertisement playback intervals from watch time accumulation and assigns identifiers to individual watch time units such that each unit can be independently evaluated, tracked, and transitioned between monetization states.

System 1000 further includes a monetization eligibility state controller 1006 configured to maintain and update a monetization eligibility state for each watch time unit. The monetization eligibility state controller 1006 evaluates advertisement consumption events to determine whether monetization conditions are satisfied and transitions watch time units between non-monetized, conditionally eligible, monetized, and invalidated states based on verified advertisement completion or skipping behavior.

System 1000 further includes a temporal correlation engine 1008 configured to associate advertisement consumption events with one or more watch time units using defined temporal correlation rules. The temporal correlation engine 1008 determines whether monetization eligibility applies to watch time units occurring before an advertisement, after an advertisement, or within a defined adjacency threshold, based on an advertisement placement context that includes pre-roll, mid-roll, and post-roll classifications.

System 1000 further includes a monetized watch time valuation engine 1010 configured to compute a per-unit monetary value for monetized watch time units. The monetized watch time valuation engine 1010 aggregates verified advertisement earnings, applies a creator allocation prior to viewer valuation, excludes invalidated or non-monetized watch time units from a valuation denominator, and computes a value for each monetized watch time unit using deterministic arithmetic operations.

System 1000 further includes a verification and reconciliation module 1012 configured to validate the integrity of playback events and advertisement consumption events. The verification and reconciliation module 1012 reconciles device-side timestamps with server-side logs, validates session identifiers, detects anomalous timing behavior, and suppresses monetization eligibility for watch time units associated with unverified or inconsistent event data.

System 1000 further includes a revenue allocation module 1014 configured to allocate verified advertisement earnings among a content creator, a viewer, and a platform operator based on monetized watch time units and computed per-unit values. The revenue allocation module 1014 produces auditable allocation outputs derived from monetization eligibility states rather than abstract engagement metrics.

In this manner, system 1000 implements a concrete, computer-controlled mechanism that governs when content watch time becomes monetizable, how advertisement events causally affect monetization eligibility, and how revenue is computed and allocated using verified event data. The system improves the operation of computer-based media platforms by enforcing conditional state transitions, temporal correlation constraints, and deterministic calculations that are not achievable through generic accounting or conventional advertisement tracking systems.

In some embodiments, system 1000 operates on structured data representations stored in non-transitory memory, including event records, watch time unit records, monetization state tables, and revenue ledger entries. Each watch time unit is represented as a discrete data object comprising a unit identifier, content identifier, temporal boundaries, an associated monetization eligibility state, and one or more verification flags. These data objects are stored in memory-resident tables or persistent storage structures and are updated through processor-executed instructions as playback and advertisement consumption events are received.

In some embodiments, the monetization eligibility state controller maintains a state table implemented as an indexed data structure that maps watch time unit identifiers to monetization eligibility states. State transitions are performed by writing updated state values into the state table in response to verified advertisement consumption events and temporal correlation determinations. The state table is accessed by multiple modules of system 1000 to enforce exclusion of invalidated watch time units from valuation, allocation, and reporting operations, thereby providing a centralized and machine-enforced control mechanism.

In some embodiments, advertisement consumption events and content playback events are stored as time-ordered event records comprising event type fields, timestamp fields, session identifiers, and content or advertisement identifiers. The temporal correlation engine operates by executing processor instructions that compare timestamp fields of advertisement events against time boundaries of watch time unit records stored in memory. Based on these comparisons, the system establishes explicit associations between advertisement events and one or more watch time unit records, which are recorded as references within the corresponding data objects.

In some embodiments, monetized watch time valuation and revenue allocation are implemented using ledger-style data structures stored in persistent storage. Advertisement earnings are recorded as numeric entries associated with verified advertisement events, and allocation outputs are recorded as ledger entries associated with creator identifiers, viewer identifiers, and platform identifiers. These ledger entries include computed allocation amounts and accounting timestamps, enabling auditability and reproducibility of monetization outcomes through machine-readable records rather than inferred engagement metrics.

In some embodiments, the verification and reconciliation module performs hardware-assisted validation by comparing device-generated timestamps received over network interfaces with server-generated timestamps produced by system clocks of backend computing devices. Discrepancies exceeding defined thresholds cause corresponding watch time unit records to be marked with invalidation flags stored in memory. Processor-executed filtering operations prevent watch time units marked with invalidation flags from being included in monetization eligibility counts, valuation denominators, or revenue allocation calculations.

System 1000 implements the ad-conditioned monetization control by coordinating event ingestion, time segmentation, state management, temporal correlation, valuation, verification, and allocation. FIGS. 6-9 describe the operational processes that execute within System 1000, while the equations provide deterministic arithmetic applied to the outputs of those processes. Each module in System 1000 produces or consumes concrete data structures that directly parameterize the equations.

Event ingestion module 1002 supplies the foundational event data consumed by FIGS. 6 and 9 by normalizing content playback events and advertisement consumption events into structured records with timestamps, identifiers, and verification flags. These records provide the factual inputs used to determine advertisement completion and skipping behavior, which directly inform the eligibility indicator E_i for each watch time unit and the inclusion of advertisement earnings R_j in the total earnings aggregation.

Watch time segmentation module 1004 operates in conjunction with FIGS. 6 and 7 to compute content-only playback duration and to generate fixed-length watch time unit records. The module computes T_content and derives WTU_total using the floor operation └T_content/U┘, while excluding advertisement playback intervals. The resulting WTU_i records serve as the atomic units evaluated by the eligibility controller and the temporal correlation engine.

Monetization eligibility state controller 1006 implements FIG. 6 by evaluating advertisement completion criteria and updating monetization eligibility states for individual watch time units. The controller assigns the eligibility indicator E_i for each WTU_i based on verified ad completion and temporal association outcomes, thereby determining WTU_monetized=ΣWTU_i·E_i. Watch time units associated with skipped, interrupted, or unverified advertisements are transitioned to an invalidated state and excluded from monetization.

Temporal correlation engine 1008 implements FIG. 7 by associating advertisement events with specific watch time units according to placement context and directional rules. By defining temporal correlation windows and associating only those WTU_i that fall within the windows, the engine constrains which watch time units may receive E_i=1. This association ensures that advertisement earnings are causally linked to discrete segments of content watch time rather than inferred from aggregate viewing behavior.

Monetized watch time valuation engine 1010 implements FIG. 8 by aggregating verified advertisement earnings to compute E_total=ΣR_j, applying the creator allocation E_creator=α·E_total, determining E_remaining, and computing the per-unit value V_WTU=(β·E_remaining)/WTU_monetized. The valuation engine operates exclusively on monetized watch time units and excludes invalidated units from the denominator, producing deterministic, revenue-backed unit values.

Verification and reconciliation module 1012 implements FIG. 9 by validating the integrity of event timestamps and session identifiers prior to valuation and allocation. Failed verification results in explicit invalidation flags on affected WTU_i records, enforcing E_i=0 for those units and preventing their inclusion in WTU_monetized and downstream calculations.

Revenue allocation module 1014 consumes the per-unit value V_WTU and the count of monetized watch time units to compute viewer rewards E_viewer=WTU_monetized·V_WTU and platform earnings E_platform=E_remaining−E_viewer. These outputs integrate with the distribution mechanisms illustrated earlier and are recorded as ledger entries, completing the end-to-end flow from event ingestion through state control, valuation, and allocation.

In some embodiments, a computer-implemented system executes ad-conditioned monetization control by processing structured playback and advertisement consumption events through coordinated modules that segment content watch time, manage monetization eligibility states, correlate advertisement events to discrete time segments, and perform deterministic valuation and allocation operations. Event records comprising timestamps and identifiers are ingested and normalized, content playback duration is segmented into fixed-length watch time units excluding advertisement intervals, and a monetization eligibility state is assigned to each watch time unit based on verified advertisement completion and defined temporal correlation rules for pre-roll, mid-roll, and post-roll placements. Advertisement earnings generated from verified, non-skipped advertisements are aggregated and processed using arithmetic operations to allocate a creator share, compute a remaining earnings pool, and calculate a per-unit monetary value based on a count of monetized watch time units, while watch time units associated with skipped or unverified advertisements are explicitly invalidated and excluded from valuation. Verification and reconciliation logic validates event integrity prior to valuation, and revenue allocation outputs are generated as machine-readable ledger entries for creators, viewers, and a platform operator. By enforcing explicit state transitions, temporal causality constraints, and deterministic calculations on memory-resident data structures, the system improves the operation of computer-based media platforms by controlling when and how watch time becomes monetizable rather than treating watch time as monetized by default.

The disclosed system explicitly recognizes that advertisement playback without subsequent or prior qualifying content playback does not generate monetized watch time units. Advertisement consumption events are treated as conditional triggers that activate monetization eligibility for temporally correlated content watch time rather than as independent monetization activities. In this framework, an advertisement served and fully consumed in isolation from content watch time does not result in any monetized watch time units, and advertisement earnings from such isolated consumption are not allocated using the watch time unit valuation mechanism. This structural dependency ensures that monetization is causally linked to content engagement rather than to advertisement impressions alone, thereby distinguishing the disclosed approach from impression-based or view-through monetization models in which advertisement serving alone may constitute a monetizable event.

Monetization eligibility determination and state transitions are machine-controlled at the platform level and are not client-authoritative. The system enforces monetization eligibility states through server-side processing components that evaluate structured event records, apply temporal correlation rules, and update state tables stored in platform-controlled memory resources. Client devices generate playback event data and advertisement consumption event data, but such client-generated data does not directly determine monetization eligibility without server-side verification, reconciliation, and validation. By centralizing eligibility control within platform infrastructure, the system resists client-side manipulation, event spoofing, and unauthorized state transitions that could otherwise enable fraudulent monetization of watch time units. This architectural constraint ensures that monetization eligibility states reflect verified platform observations rather than client assertions.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed by United States patent:

1. A computer-implemented method for controlling monetization of watch time in a user-generated video sharing platform, the method comprising:
receiving, by one or more processors, structured playback event records and advertisement consumption event records comprising timestamps, identifiers, and event types;
segmenting, by the one or more processors, content playback duration into fixed-length watch time units while excluding advertisement playback intervals;
detecting, by the one or more processors, one or more advertisement consumption events and determining whether each detected advertisement consumption event satisfies completion criteria without skipping;
associating, by the one or more processors, at least one advertisement consumption event with one or more watch time units using defined temporal correlation rules based on an advertisement placement context;
updating, by the one or more processors, a monetization eligibility state for each associated watch time unit based on the advertisement consumption event and the temporal correlation rules, including transitioning watch time units into a monetized state or an invalidated state;
aggregating, by the one or more processors, advertisement earnings from verified advertisement consumption events;
computing, by the one or more processors, a per-unit monetary value for monetized watch time units using deterministic arithmetic operations based on aggregated advertisement earnings and a count of monetized watch time units; and
generating, by the one or more processors, revenue allocation outputs for a content creator, a viewer, and a platform operator based on the per-unit monetary value and the monetized watch time units.

2. The method of claim 1, wherein segmenting the content playback duration comprises computing a total content watch time and dividing the total content watch time by a fixed watch time unit duration using a floor operation.

3. The method of claim 1, wherein the defined temporal correlation rules specify that, for a pre-roll or mid-roll advertisement, monetization eligibility applies to watch time units occurring after the advertisement consumption event.

4. The method of claim 1, wherein the defined temporal correlation rules specify that, for a post-roll advertisement, monetization eligibility applies to watch time units occurring before the advertisement consumption event.

5. The method of claim 1, wherein updating the monetization eligibility state comprises maintaining a state table in memory that maps watch time unit identifiers to monetization eligibility states.

6. The method of claim 1, wherein transitioning a watch time unit into the invalidated state causes the watch time unit to be excluded from the count of monetized watch time units and from valuation calculations.

7. The method of claim 1, wherein detecting advertisement consumption events comprises distinguishing between full completion events, partial playback events, and skipping events based on event type fields in the structured event records.

8. The method of claim 1, further comprising verifying integrity of the structured playback event records by reconciling device-generated timestamps with server-generated timestamps prior to computing the per-unit monetary value.

9. The method of claim 8, wherein watch time units associated with playback event records failing verification are transitioned into the invalidated state.

10. The method of claim 1, wherein aggregating advertisement earnings comprises summing numeric earnings values associated only with advertisement consumption events that satisfy completion criteria.

11. The method of claim 1, wherein computing the per-unit monetary value comprises allocating a creator share from the aggregated advertisement earnings prior to dividing a remaining earnings pool by the count of monetized watch time units.

12. The method of claim 1, wherein the per-unit monetary value is stored in a valuation data structure accessible by a revenue allocation module.

13. The method of claim 1, wherein generating the revenue allocation outputs comprises recording allocation entries as machine-readable ledger records comprising participant identifiers and allocation amounts.

14. The method of claim 1, wherein the method is executed in real time or near real time as structured playback event records are received during content playback.

15. The method of claim 1, wherein the method improves operation of the user-generated video sharing platform by enforcing machine-controlled monetization eligibility state transitions that prevent watch time from being treated as monetized by default.

16. The method of claim 1, wherein viewer rewards comprise one or more of: monetary allocations, redeemable credits, stored value units, platform-defined reward instruments, or other redeemable value representations.
